(19) United States
(12) Patent Application Publication
(10) Pub. No.: US 2006/0283065 A1
(43) Pub. Date: Dec. 21, 2006

(54) Digital conversation piece table

(76) Inventors: Marilyn V. Wilson, Indianapolis, IN (US); Nicole M.L. Wilson-Cole, Indianapolis, IN (US)

Correspondence Address: Marilyn Virginia Wilson;4066 Rockwood Ave., P.O. Box 88121, Indianapolis, IN, 46208, US

(21) Appl. No.: 10/353,346

(22) Filed: May 16, 2005

(51) Int. Cl. G09F 13/00

(52) U.S. Cl. 40/541

(57) ABSTRACT

The new art of my invention pertains to be able to leave messages on your table or any office desk, or at your cubicle. An example is like if your manager wants you in her office and she comes to your desk and writes a note on a piece of paper, she would not have to do that). She can type it in or leave a message by blocks or typing center that is a dual combination. It can be used in all office settings and work settings, and it can also be a novelty in your home for a conversation piece. It can be used with the tray inside and it opens up to leave message or type in message on the typing center with a box that is computerized to leave message and be able to use more than one letter.

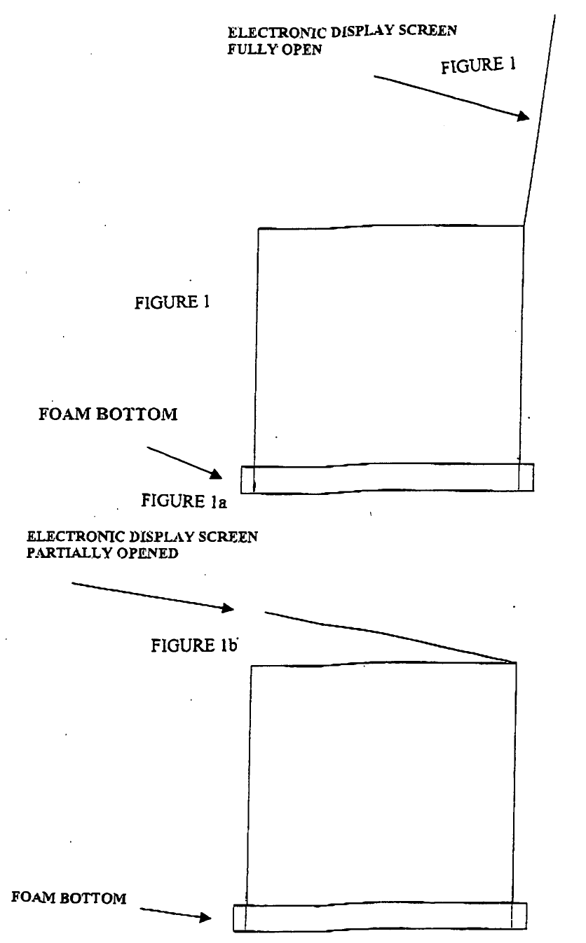

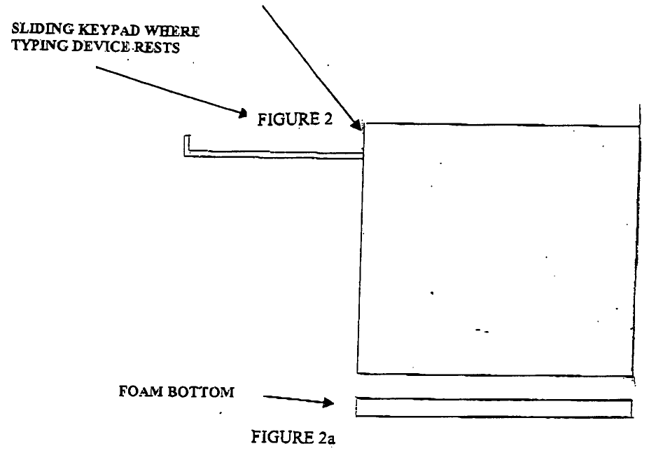

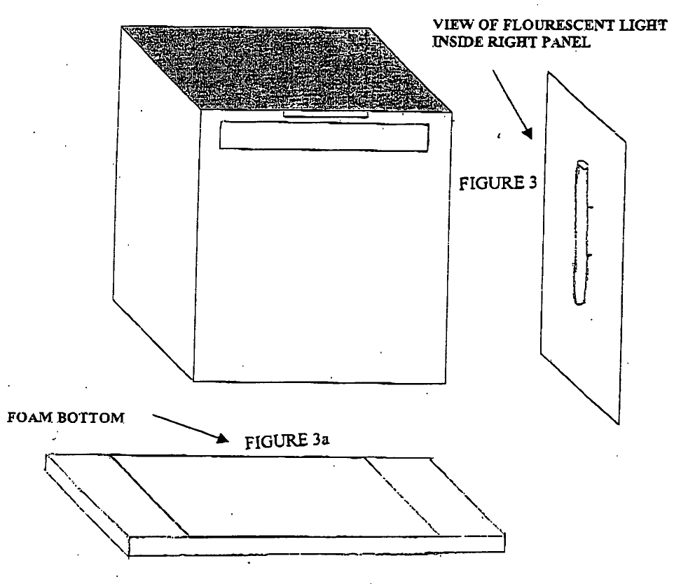

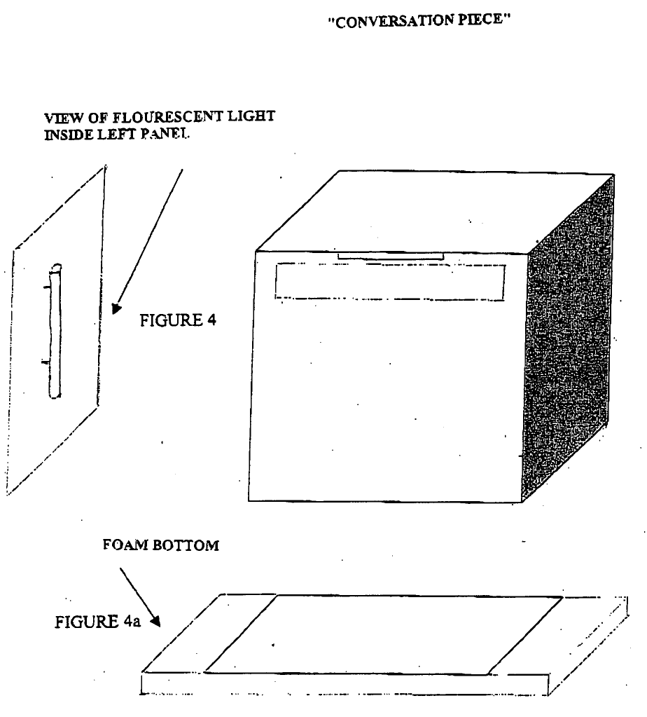

1. The table be at least 36 by 36 square or different sizes. Digital table conversation piece with the alphabet and numbers from 1 to 100 included. About 6 inches from the end of the table will be a typing center or you can use blocks for the alphabet and numbers also. The rest of the area will be the message area, when leaving a message. Their also can be flourescent lights at the bottom to light up the table whan a message is being left.

### DESCRIPTION OF INVENTION

Title: Conversation Piece Digital

36 by 36

Made of plexiglass and foam

Flourescent lights

The alphabet and the numbers 1 through 100

Digital buttons to leave message

To be able to move around alphabet and numbers

Different colors (red, green, yellow, orange, etc.

What the table does is plug in the wall and you are able to leave a message if you leave home and want to let someone know where you are or where you are going. It will be clear like a box square, any other shapes can be made also. It is for novelty, offices and places like pier one and art museums.

1. I claim the Conversation Piece Digital Table will be a message center Where you can leave messages by touching buttons with the alphabet, and Numbers on the buttons and it will electronic on top of the table where Your message will appear. Their will be a tray that you can pull out and Leave messages manually on it. This tray or table can also be digital And you are able to leave a message on top of the table once typed in.
Their will be 2 different concepts.
Specifications: The table will be 36 by 36 mainly list it can be different Sizes and shapes.
1. Their will be fluorescent lights at the bottom about 4 inches from the The bottom and lights on the side about 4 inches out.
2. The lights can be different colors.
3. The table will give artistic decorative effect.
4. The design is changeable to give varying visual effects:
5. Uniqueness gives it a conversation piece appeal:
6. There are variations from transparent to translucent interest bodies Give optionally variable effects:
7. Although distinctively unique design display, the module may be used also in a conventional coffee table use;
8. Optional variations of nature provide an ongoing challenge to the Home owner or decorator; and can be made to blend in with various Styles of room furniture.
